(19) United States
(12) Patent Application Publication
(10) Pub. No.: US 2015/0209925 A1
(43) Pub. Date: Jul. 30, 2015

(54) AUTO CHANGER SPINDLE MOUNTING ASSEMBLY ADAPTED TO DRILL TAP MACHINES

(71) Applicant: Air Turbine Technology, Inc., Boca Raton, FL (US)

(72) Inventor: Kemma Samuel Dodds, North Lauderdale, FL (US)

(21) Appl. No.: 14/414,293

(22) PCT Filed: Jul. 11, 2013
(86) PCT No.: PCT/US2013/049998

§ 371 Date: Jan. 12, 2015

Related U.S. Application Data
(63) Continuation-in-part of application No. 13/546,089, filed on Jul. 11, 2012.

(51) Int. Cl. B23Q 3/157

(52) U.S. Cl. CPC B23Q 3/15733

(57) ABSTRACT

Described is a novel spindle mounting assembly for use with a computer numeric controlled (CNC) machine, such as a drill tap machine. In one example an auto changer spindle mounting assembly includes a collar with a gas inlet. The collar defines a collar opening therethrough to create a passage between the first side of the collar with the second side of the collar. The collar further includes a passage in fluid communication between the gas inlet and through a nipple to the collar opening. The mounting assembly includes a manifold body with a gas outlet adapted to mate with the gas inlet of the collar, the manifold body defined a passage in fluid communications between, the gas outlet and a manifold body inlet. Also included is at least one extension bar, adapted to mechanically fasten to the manifold body to a computer controlled machine.

### CROSS REFERENCE TO RELATED APPLICATION

This application is based upon and claims priority to U.S. patent application Ser. No. 13/546,089, entitled “AUTO CHANGER SPINDLE MOUNTING ASSEMBLY ADAPTED TO DRILL TAP MACHINES”, filed on Jul. 11, 2012, the disclosure of which is hereby incorporated by reference in its entirety.

### FIELD OF THE INVENTION

This disclosure relates generally to machining processes and more specifically to an apparatus and method for machining.

### BACKGROUND

Computer Numerical Control (CNC) machines are utilized in machining processes, and utilize a computer controller that typically reads G-code instructions for driving a powered mechanical device that is used to fabricate metal components by the selective removal of metal. CNC can do numerically directed interpolation of a cutting tool in the work envelope of a machine.

The powered mechanical device is often a pneumatic tool (e.g., a drill) that is fitted for coupling with the CNC machine, such as by insertion into and withdrawal from a CNC machine. The pneumatic tools or spindles can be manually coupled with the CNC machine or an automatic tool changer can be utilized.

Some tools are available from a CNC tool magazine, but require that the machine be stopped after change-over so that suitable power connections can be established with the tool. Other tools are pre-connected to the pneumatic source, but must be manually engaged with the CNC machine. Thus, CNC machines are typically programmed to stop prior to the normal machining cycle to permit manual tool installation or creation of a suitable power link with the tool after coupling with the machine.

Accordingly, there is a need for an apparatus and method for machining that facilitates the tool exchanging process. There is a further need for such an apparatus and method that provides flexibility to use various types of tools.

### SUMMARY

An apparatus and method for machining is provided. The features of the examples described herein can allow for machining while facilitating the tool exchanging process. These features can also provide flexibility to use various types of tools with the CNC machine or other control device.

Described is a novel spindle mounting assembly for use with a computer numeric controlled (CNC) machine, such as a drill tap machine. In one example an auto changer spindle mounting assembly includes a collar with a gas inlet. The collar defines a collar opening therethrough to create a passage between the first side of the collar with the second side of the collar. The collar further includes a passage in fluid communication between the gas inlet and through a nipple to the collar opening. The mounting assembly includes a manifold body with a gas outlet adapted to mate with the gas inlet of the collar, the manifold body defined a passage in fluid communications between, the gas outlet and a manifold body inlet. Also included is at least one extension bar, adapted to mechanically fasten to the manifold body to a computer controlled machine.

The auto changer spindle mounting assembly may include a check valve adapted to allow a gas to pass into the gas inlet above a given pressure. Further, to fasten to the CNC machine, the extension bar includes a mounting plate with one or more openings therethrough adapted to accept fasteners. For example, the extension bar, further comprises one or more threaded openings and the mounting plate includes a corresponding number of openings therethrough adapted to accept fasteners for fastening to the mounting plate to the extension bar.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is perspective view of an exemplary machining system according to an embodiment of the present invention;

FIG. 2 is a perspective view of another portion of the system of FIG. 1;

FIG. 3 is a side view of a spindle and mounting collar assembly of the system of FIG. 1;

FIG. 4 is a side view of the mounting plate of FIG. 3;

FIG. 5 is a side view of the extension bar of FIG. 3; and

FIG. 6 is bottom view of the mounting block or manifold body of FIG. 2 and FIG. 3.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term another, as used herein, is defined as at least a second or more. The terms “including” and “having” as used herein, are defined as comprising (i.e. open language). The term “coupled” as used herein, is defined as “connected” although not necessarily directly, and not necessarily mechanically.

The term “air” is intended to broadly cover many different types of fluids, including oil mixed with air. Various materials or combinations of materials can be used to construct the mounting collar assembly and its components. For example, materials such as metals, alloys, composites, plastics, ceramics, and other inorganic or organic materials or combinations thereof may be used.

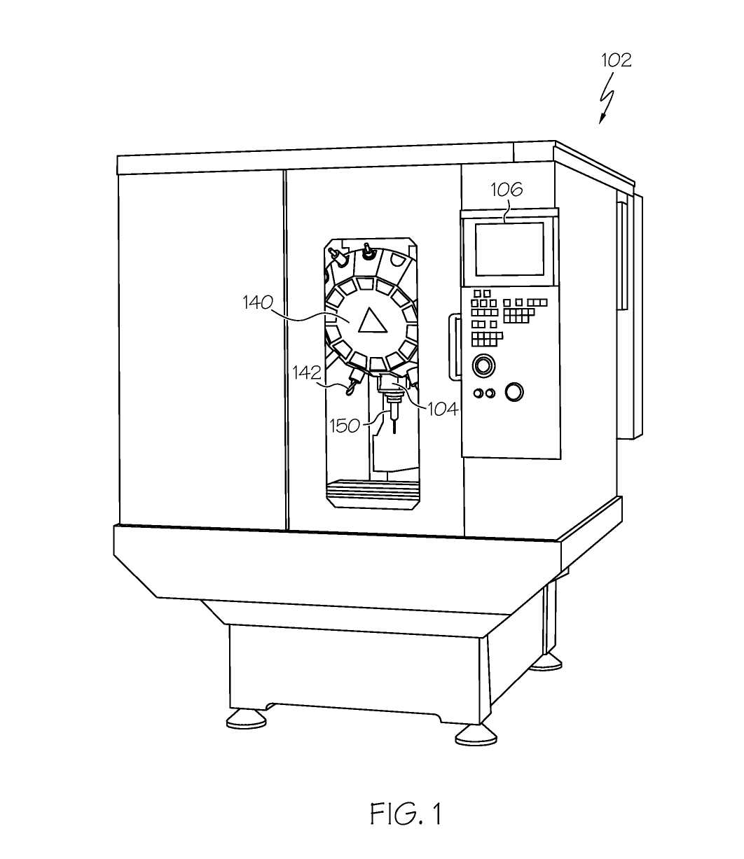

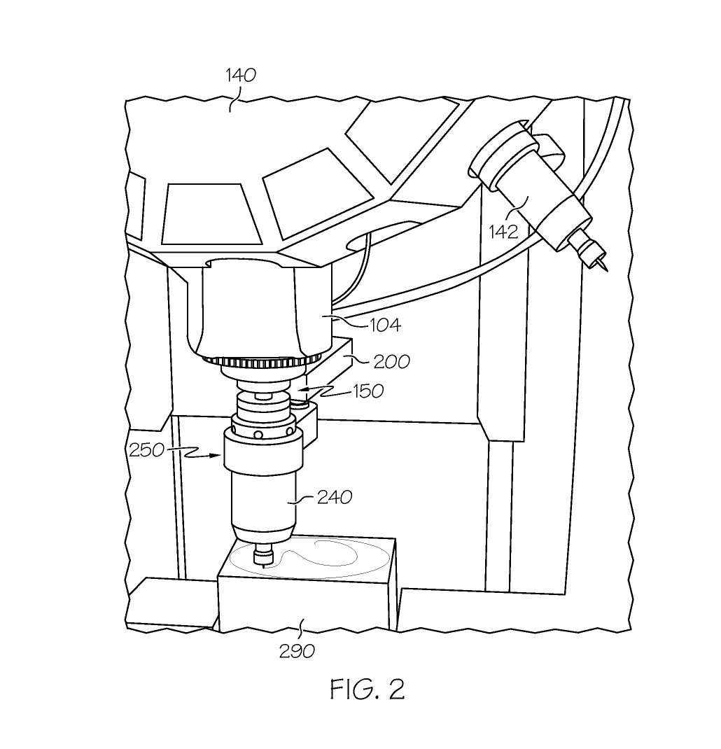

Referring to the drawings, and in particular to FIGS. 1-2, a machining system is shown and generally represented by reference numeral 102. System 102 can include a control device 104, such as a CNC machine, a tool carousel 140, and one or more tools or spindles 142. The control device 104 can include a user input device 106 for inputting commands. The control device 104 can utilize various computational hardware and software to implement a machining process on a work piece, and the present disclosure is not intended to be limited based upon the type of control utilized.

The system 102 can also have a universal spindle mounting assembly (USMA) 150 that cooperates with the spindles 142 to allow for automatic exchanging of the spindles with the CNC machine 104. In the exemplary embodiment of system 102, the spindles 142 are exchanged between the CNC machine 104 and the tool carousel 140 by way of an auto changer device, which will be explained later in greater detail. However, the present disclosure contemplates the use of other structures and techniques for connecting and disconnecting the spindles 142 with the CNC machine 104 through use of the USMA 150, such as a linear carousel.

Referring to FIG. 2, the USMA 150 can include a mounting collar assembly 250 and a mounting block or manifold body 200. The mounting collar assembly 250 can be operably coupled to the spindle 240, while the mounting block or manifold body 200 can be operably coupled to the CNC machine 104. A workpiece 290 is shown being machined with system 102.

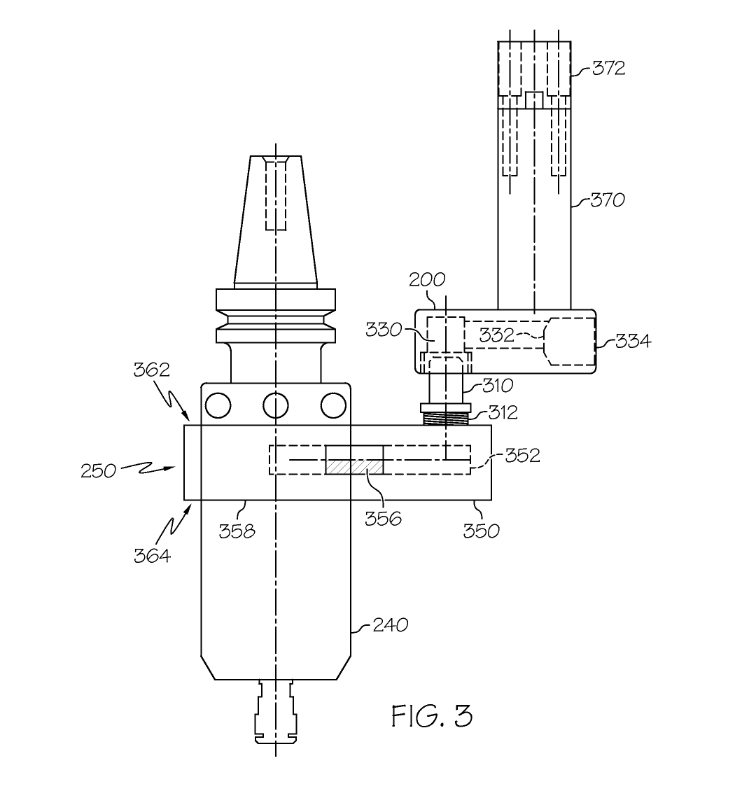

More specifically, FIG. 3 illustrates the novel mounting assembly 250 with mounting collar 350 attached to the spindle 240. The mounting collar 350 has a top side 362 and a bottom side 364. Mounting collar 350 includes a collar opening 358 which is formed therethrough between the top side 362 and bottom side 364 as shown. The collar opening 358 is sized to accept a portion spindle 240 therethrough as shown. A nipple opening 356 enables fluid communication between the collar opening 358 and passage 352. A lock screw inside the nipple opening 356 may be used to secure the spindle 240 to the mounting collar 350.

The mounting collar 350 includes a passage 352 in fluid communication between an air inlet assembly 310 and the collar opening 358. The air inlet assembly 310 has a threaded end 312 for inserting into the mounting collar 350. In one example, air inlet assembly 310 includes a spring-loaded check valve that opens above a given pressure to allow liquid, such as air, to flow into the air inlet assembly 310. The use of a check-valve greatly reduces any dirt and undesirable debris from entering the air inlet assembly 310. This is especially important when the mounting collar 350 and spindle 240 are stored in the tool carousel and/or not being used.

The mounting block or manifold body 200 includes an opening 330 for accepting inlet assembly 312. A passage within the mounting block or manifold body 200 to provide fluid communications between the opening 330 to inlet assembly 312 and between opening 334 to opening 330 for system air supply.

An extension bar 370 is mechanically coupled to a mounting plate 372, which is fastened to system 102 holding the entire mounting collar assembly 250 and spindle 240 firmly in place.

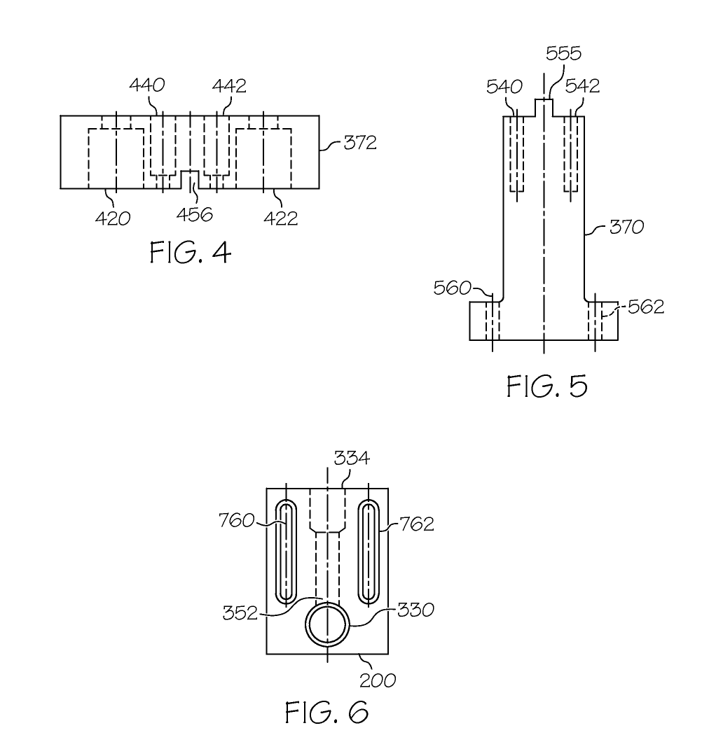

Referring additionally to FIGS. 4-5, are side views of the details of the extension bar 370 and mounting plate 372 of FIG. 3. Shown are a set of counterbore openings 420 and 422 for use with fasteners, such as bolts or screws (not shown), to system 102. Also shown are a set of counterbore openings 440, 442 for use with fasteners going into threaded opening 540, 542 of extension bar 370 in FIG. 5. Although the term counterbore is being used, other types of openings including countersinks and straight bores to accommodate other types of fasteners are within the scope of the present invention. A recess 456 in mounting plate 372 is adapted to accept the alignment pin 555 on end of extension arm 370.

FIG. 6 is a bottom view of the mounting block or manifold body shown in FIGS. 2 and 3. Two slotted openings 760, 762 in the mounting block or manifold body 200 are shown to accept and align with the corresponding two openings 560, 562 and to insert fasteners therethrough.

The inventors have discovered the use of extension bar and mounting plate with this fastener configurations provide backward compatibility with existing tool designs. The mounting plate openings 420, 422 align with existing holes in the system typically used for transporting the system 102 and not used during production.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed as the best mode contemplated for carrying out this invention, but that the invention will include all embodiments falling within the scope of the appended claims.

What is claimed is:

1. An auto changer spindle mounting assembly comprising:
a collar with a gas inlet, the collar defines a collar opening therethrough to create a passage between the first side of the collar with the second side of the collar, wherein the collar further defines a passage in fluid communication between the gas inlet and through a nipple to the collar opening;
a manifold body with a gas outlet adapted to mate with the gas inlet of the collar, the manifold body defines a passage in fluid communications between, the gas outlet and a manifold body inlet; and
at least one extension bar, adapted to mechanically fasten to the manifold body to a computer controlled machine.

2. The auto changer spindle mounting assembly of claim 1, wherein the gas inlet of the collar includes a check valve adapted to allow a gas to pass into the gas inlet above a given pressure.

3. The auto changer spindle mounting assembly of claim 1, wherein the extension bar further comprises a mounting plate with one or more openings therethrough adapted to accept fasteners for fastening to the computer controlled machine.

4. The auto changer spindle mounting assembly of claim 2, wherein the extension bar further comprises a mounting plate with one or more openings therethrough adapted to accept fasteners for fastening to the computer controlled machine.

5. The auto changer spindle mounting assembly of claim 4, wherein the extension bar further comprises one or more threaded openings and the mounting plate includes a corresponding number of openings therethrough adapted to accept fasteners for fastening to the mounting plate to the extension bar.

6. A machining system comprising:
a spindle;
a CNC machine;
an auto changer device;
a gas supply line; and
a mounting assembly including
a gas inlet in fluid communications with the gas supply line;
a collar with a gas inlet, the collar defines a collar opening therethrough to create a passage between the first side of the collar with the second side of the collar, wherein the collar further defines a passage in fluid communication between the gas inlet and through a nipple to the collar opening;
a manifold body with a gas outlet adapted to mate with the gas inlet of the collar, the manifold body defines a passage in fluid communications between, the gas outlet and a manifold body inlet; and
at least one extension bar, adapted to mechanically fasten to the manifold body to a computer controlled machine.

7. The system of claim 6, wherein the, wherein the gas inlet of the collar includes a check valve adapted to allow a gas to pass into the gas inlet above a given pressure.

8. The system of claim 6, wherein the extension bar further comprises a mounting plate with one or more openings therethrough adapted to accept fasteners for fastening to the computer controlled machine.

9. The system of claim 7, wherein the extension bar further comprises a mounting plate with one or more openings therethrough adapted to accept fasteners for fastening to the computer controlled machine.

10. The system of claim 9, wherein the extension bar further comprises or more threaded openings and the mounting plate includes a corresponding number of openings therethrough adapted to accept fasteners for fastening to the mounting plate to the extension bar.
